(19) United States
(12) Patent Application Publication
(10) Pub. No.: US 2017/0357679 A1
(43) Pub. Date: Dec. 14, 2017

(54) Contextual Styling of Chart Elements

(71) Applicant: SAP SE, Walldorf (DE)

(72) Inventors: Viren Kumar, Vancouver (CA); Amir Hajizadeh, Vancouver (CA)

(21) Appl. No.: 15/182,399

(22) Filed: Jun. 14, 2016

(51) Int. Cl. G06F 17/30; G06F 3/0484; G06F 17/27; G06F 21/62; G06T 11/20

(52) U.S. Cl. CPC G06F 17/30345; G06F 21/62; G06F 17/30312; G06T 11/206; G06F 17/30424; G06F 17/2705; G06F 3/04845

(57) ABSTRACT

Embodiments implement contextual styling of chart elements based upon metadata stored in the data layer associated with chart data. In creating a chart for the associated data, a visualization engine references the metadata to render appearance of a chart element according to the relevant metadata. This maintains consistent appearance of chart elements depicting the same data, across different chart types (e.g., bar chart and pie chart). The metadata may be stored in the data layer as a JavaScript Object Notation (JSON) object, together with a corresponding identifier (e.g., representing a unique —story/-page/-chart/-chart element combination). Metadata within the data layer may determine appearance of chart data, chart axes, chart legends, and/or chart borders. The visualization engine may consult precedence rules governing application of different metadata (e.g., as between the appearance of a dimension vs. the appearance of a specific tuple including that dimension).

### BACKGROUND

Unless otherwise indicated herein, the approaches described in this section are not prior art to the claims in this application and are not admitted to be prior art by inclusion in this section.

Embodiments relate to storage and visualization of data, and in particular to methods and apparatuses implementing styling of chart elements based upon contextual information. Certain embodiments store in a data layer, past chart styles implemented by a particular user, and then automatically visualize information according to that stored contextual information.

Databases and overlying applications referencing data stored therein, offer a powerful way of storing and analyzing large volumes of data that are related in various ways. In particular, discrete values of stored data may be organized into larger data structures comprising related fields.

Such larger data structures may also be referred to as data objects, and can be represented in the form of tables having rows and columns. Through the skillful and intuitive presentation of such data structures in the form of tables and charts, a user can describe complex issues and the factual/forecast data underlying those issues.

Many available systems allow a user to visualize data as a set of charts. Those systems may also allow a user to manually impose a particular appearance upon various chart elements, e.g., data points, chart legends, chart axes, etc.

Manually imposing a different appearance upon chart elements may afford a more intuitive visual appreciation for the user, allowing emphasis of important chart aspects. However, requiring a user to manually impose an appearance upon various elements each time a chart is rendered, can be time-consuming.

### SUMMARY

Embodiments implement contextual styling of chart elements based upon metadata stored in the data layer and associated with chart data. In creating a chart for the associated data, a visualization engine references the metadata to render the appearance (e.g., color, shape) of a chart element according to the relevant metadata. This approach maintains consistent appearance of chart elements depicting the same data, across different chart types (e.g., bar chart and pie chart). The metadata may be stored in the data layer as a metadata table having one column with a JavaScript Object Notation (JSON) object, and another column with a corresponding identifier representing, e.g., a unique —story/-page/-chart/-chart element combination. Stored metadata within the data layer may determine appearance of elements such as chart data, chart axes, chart legends, and/or chart borders. The visualization engine may consult precedence rules concerning the application of different metadata (e.g., governing appearance of a dimension vs. appearance of a specific tuple including that dimension).

An embodiment of a computer-implemented method comprises rendering a chart element for data from a fact table in a database, the chart element having an appearance based upon metadata from a metadata table in the database. A first input is received to change the appearance. In response to the first input, the chart element is rendered with a changed appearance. Updated metadata reflecting the changed appearance is stored in the metadata table. A second input to display the data is received. In response to the second input, the data is automatically rendered with the changed appearance according to the updated metadata.

A non-transitory computer readable storage medium embodies a computer program for performing a method comprising rendering a chart element for data from a fact table in a database, the chart element having an appearance based upon metadata from a metadata table in the database. A first input to change the appearance is received. In response to the first input, the chart element is rendered with a changed appearance, and updated metadata reflecting the changed appearance is stored in the metadata table. A second input to display the data is received. In response to the second input, the updated metadata is processed according to a precedence rule to automatically render the data with the changed appearance.

A computer system according to an embodiment comprises one or more processors and a software program, executable on said computer system. The software program is configured to cause an in-memory database engine to render a chart element for data from a fact table in an in-memory database, the chart element having an appearance based upon metadata from a metadata table in the in-memory database. A first input to change the appearance is received. In response to the first input, the software program is configured to cause the in-memory database engine to render the chart element with a changed appearance, and store in the metadata table, updated metadata including a user preference reflecting the changed appearance. A second input to display the data is received. In response to the second input, the software program is configured to cause the in-memory database engine to process the updated metadata according to a precedence rule to automatically render the data with the changed appearance.

In certain embodiments the updated metadata comprises a user preference, and the data is rendered with the changed appearance according to a precedence rule.

In some embodiments, to automatically render the data with the changed appearance, the precedence rule instructs a parser to apply the updated metadata after applying the metadata.

In various embodiments the precedence rule is based upon a scope of restriction of the user preference.

According to particular embodiments the scope of restriction reflects a number of conditions of the user preference or an amount of data matching the user preference.

In some embodiments the precedence rule instructs a parser to modify an existing precedence rule.

In certain embodiments a charting component automatically renders the data with the changed appearance in response to a plurality of calls from a parser.

According to particular embodiments a charting component automatically renders the data with the changed appearance in response to a single call from a parser.

The following detailed description and accompanying drawings provide a better understanding of the nature and advantages of embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIGS. 3-13 show various aspects of contextual styling of chart elements according to an example.

FIG. 14 illustrates hardware of a special purpose computing machine configured to implement contextual styling of chart elements according to an embodiment.

FIG. 15 illustrates an example computer system.

FIG. 16 illustrates code of a JSON object including a color user preference.

### DETAILED DESCRIPTION

Described herein are methods and apparatuses that permit contextual styling of chart elements. In the following description, for purposes of explanation, numerous examples and specific details are set forth in order to provide a thorough understanding of the present invention. It will be evident, however, to one skilled in the art that embodiments of the present invention as defined by the claims may include some or all of the features in these examples alone or in combination with other features described below, and may further include modifications and equivalents of the features and concepts described herein.

Embodiments implement contextual styling of chart elements based upon metadata stored in the data layer and associated with chart data. In creating a chart for the associated data, a visualization engine references the metadata to render appearance of a chart element according to the relevant metadata. This maintains consistent appearance of chart elements depicting the same data, across different chart types (e.g., bar chart and pie chart). The metadata may be stored in the data layer as a JavaScript Object Notation (JSON) object, together with a corresponding identifier (e.g., representing a unique —story/-page/-chart/-chart element combination). Metadata within the data layer may determine appearance of chart data, chart axes, chart legends, and/or chart borders. The visualization engine may consult precedence rules to resolve potential conflicts arising from applying different metadata (e.g., as between the appearance of a dimension vs. the appearance of a specific tuple including that dimension).

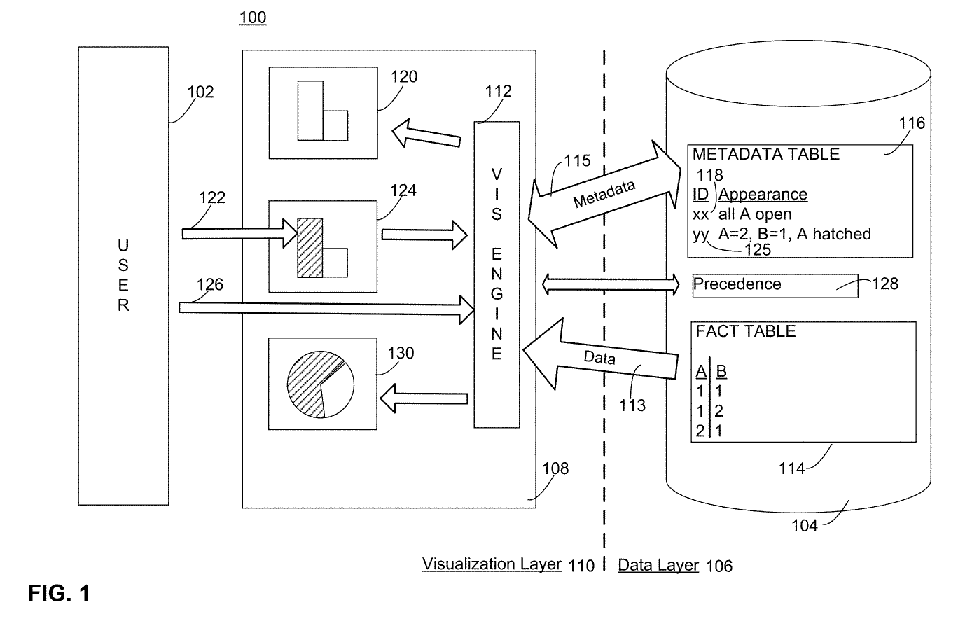

FIG. 1 presents a simplified view of a system 100 according to an embodiment. In particular, user 102 is in communication with data in a database 104 of an underlying data layer 106, via a visualization application 108 present in a visualization layer 110.

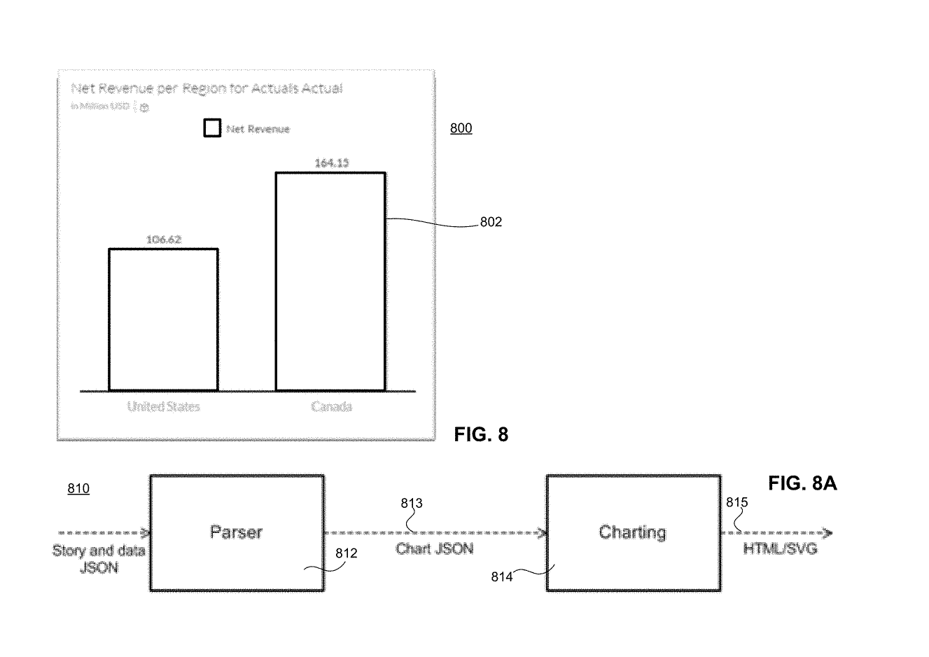

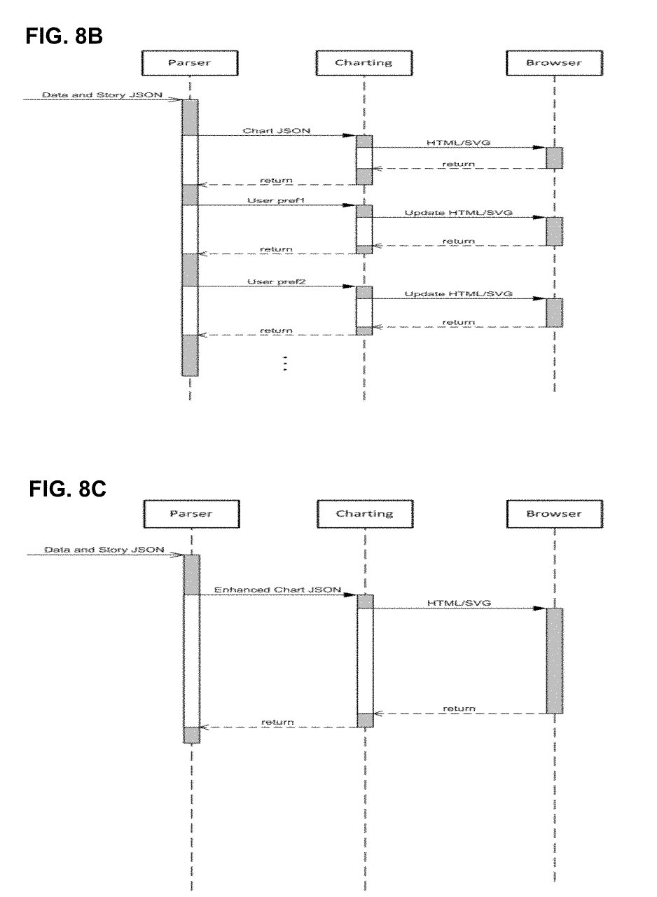

The visualization application includes a visualization engine 112. As further shown and described below in connection with FIGS. 8A-8C, the visualization engine may comprise a parser and a charting component.

The visualization engine is configured to receive data 113 from a fact table 114 stored in the database. Here, the fact table is depicted as comprising measure values for two dimensions: A and B. As described later below, in specific embodiments that data may be communicated as a data object formatted according to JavaScript Object Notation (JSON).

The visualization engine is also configured to receive metadata 115 from a metadata table 116 present in the database. Specific embodiments may also communicate that metadata in the form of a JSON object.

In FIG. 1, the metadata table includes a respective identifier for each unique chart element, and metadata indicating an appearance for that unique chart element. Here, an initial metadata identifier 118 indicates that dimension A is to be depicted in a chart as open, rather than hatched.

The visualization engine receives the data and the metadata, and constructs therefrom a first chart visualization 120 comprising a bar chart. Consistent with the metadata, the bar reflecting the data point of this dimension A is depicted as open rather than hatched.

Upon reviewing the first chart visualization, the user may decide to change its appearance. In particular, the user may decide that for the specific data point A=2, B=1, the data for dimension A is best shown hatched.

Accordingly, the user provides an input 122 to the visualization application, to change the appearance of the bar A from open to hatched. In response, the visualization engine changes the appearance of the bar A to hatched in an updated visualization 124.

Moreover, the visualization engine further communicates back to the data layer to change the stored metadata within the table. The visualization engine adds to the metadata table, additional metadata with identifier yy 125 indicating that for a chart element representing A=2 and B=1, that chart element is to be depicted with hatching.

FIG. 1 goes on to indicate that the user may next request 126 the visualization application to show the specific data point of A=2 and B=1, in the form of a different chart type (here a pie chart). In response, the visualization engine will again receive metadata input from the metadata table and data input from the fact table.

This time, however, the metadata table includes different instructions. On one hand, the original metadata indicates that values of dimension A are to be depicted as open. By contrast, the added metadata dictates that where A=2 and B=1, the value of dimension A is to be shown hatched.

Accordingly, the visualization engine consults a set of precedence rules 128 to resolve the conflicting instructions. Here, the more specific nature of the added metadata, takes precedence over the generality of the original metadata. The visualization engine proceeds to generate a pie chart 130 where the pie slice for A is automatically shown hatched, without requiring any manual interaction between the user and the visualization application.

Embodiments thus afford contextual stylizing of chart elements, based upon metadata stored in an underlying data layer. In response to receiving that metadata and corresponding data (e.g., query results from a query), an engine of an overlying visualization layer automatically renders a chart with an element having an appearance based upon the metadata.

Because no further manual input on the part of the user is required to afford the chart element, effort is reduced and the quality of user interaction with the visualization layer is enhanced.

Moreover, because the metadata is stored in association with the data of the underlying data layer, the appearance of the underlying data may be propagated in whatever form it is visualized (e.g., in a bar chart or in a pie chart). Again, this maintains consistency and continuity in chart appearance, without requiring manual effort by the user.

It is emphasized that FIG. 1 is highly simplified. For example, stored metadata may govern the appearance of chart elements other than specific data points (e.g., A=2, B=1). For example, metadata may be referenced to determine the appearance of chart axes. There, the metadata could be stored in association with a dimension, rather than based upon a specific tuple returned by a query result.

Other examples of chart elements which may be styled can include but are not limited to, chart legends and/or chart borders. Where stored metadata relates to the appearance of text (e.g., a chart axis and/or legend), that metadata can determine appearance properties including but not limited to, text color, text font, text size, italics, bolding, and/or underlining.

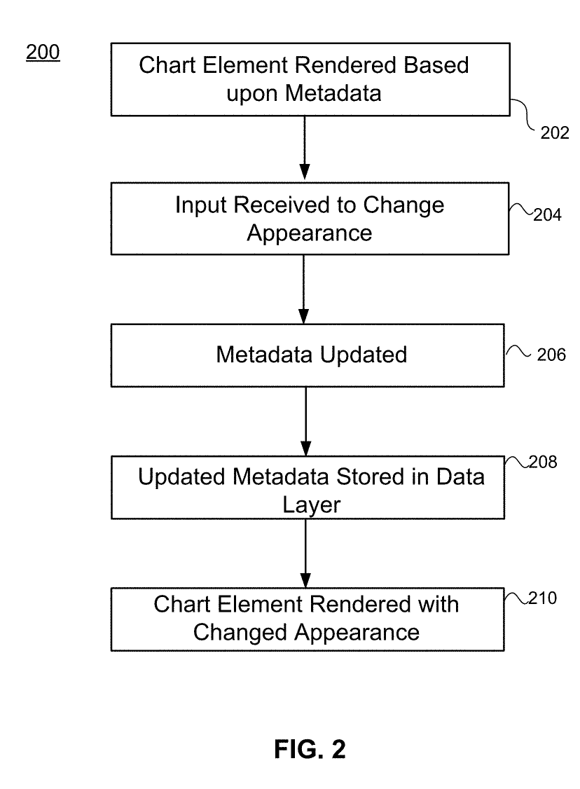

FIG. 2 is a simplified flow diagram showing a method 200 according to an embodiment. In a first step 202, a chart element is rendered based upon metadata stored in a data layer.

In a second step 204, input is received to change the appearance of the chart element. In a third step 206, the metadata is updated to reflect the change in chart element appearance.

In a fourth step 208, the updated metadata is stored in the data layer.

In a fifth step 210, a chart element is rendered with the changed appearance according to the updated metadata. In some cases that chart element may be the same chart element (e.g., bar) whose appearance was originally changed. Alternatively that chart element may be a different chart element (e.g., pie slice) visualizing data of the first chart element. As is described below, this fifth step may involve consulting precedence rule(s) governing application of the metadata.

Further details regarding aspects of chart styling according to embodiments, are now provided in connection with the following example.

### Example

This specific example of contextual styling of chart elements, is implemented via the Cloud Analytics data visualization program available from SAP SE of Walldorf, Germany. In this product, the main workflow is based upon the creation of a story.

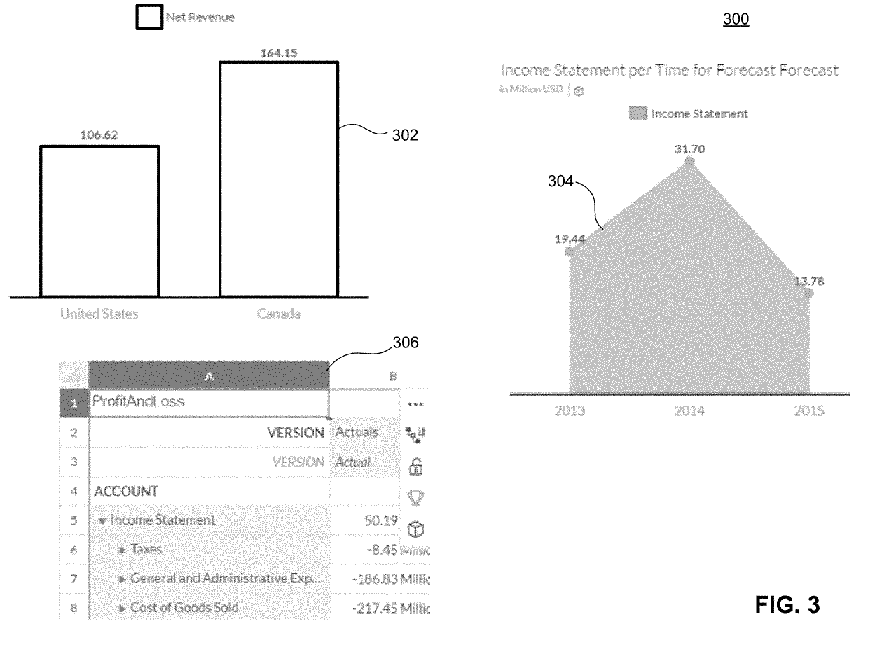

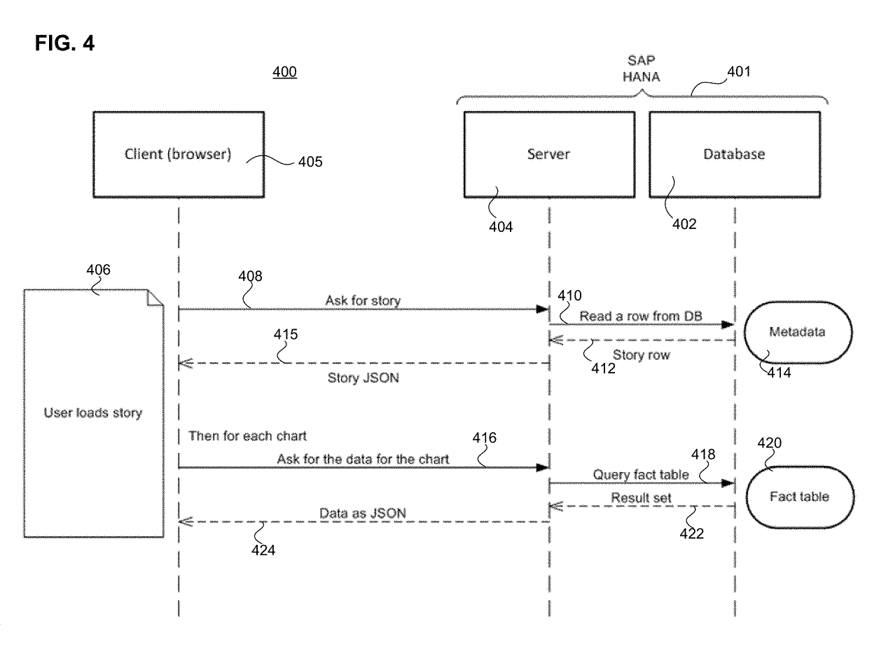

Each Cloud Analytics story may comprise several pages, and each page can have several elements. FIG. 3 shows one example of a story page 300 from the SAP Cloud Analytics platform, including visualizations 302 and 304, and data table 306.

A large pool of data may form the basis for the story page shown in FIG. 3. For example, that story page shows a variety of data types such as taxes, expenses, and cost of goods sold, taken over the years 2013-2015. Here, that data is taken from an overall dataset titled “ProfitAndLoss”.

For ease of explanation, the instant example of contextual stylizing confines itself to a simple story—the single bar chart visualization 302 in FIG. 3. That is, the story of this example comprises only net revenue per the regions of the United States and Canada.

FIG. 4 is a simplified view of the SAP Cloud Analytics platform 400. The Cloud Analytics platform is implemented with the HANA system 401 including the HANA in-memory database 402 also available from SAP SE. The data and metadata description of the story, including all of its elements, is stored in a remote server 404 on the cloud.

FIG. 4 shows communication between the client (browser) 405 and the remote server. Specifically, FIG. 4 shows the sequence of events which occur when a story is loaded 406 onto the client browser, e.g., for inspection and/or modification by the user.

Once a user selects to open/view a story, code on the client asks the database 408 for the description of that story from the server side. Code on the server then reads 410 a row from the database, which returns 412 the data from a row of the metadata table 414 containing the story description/metadata.

The schema of that metadata table is shown below.

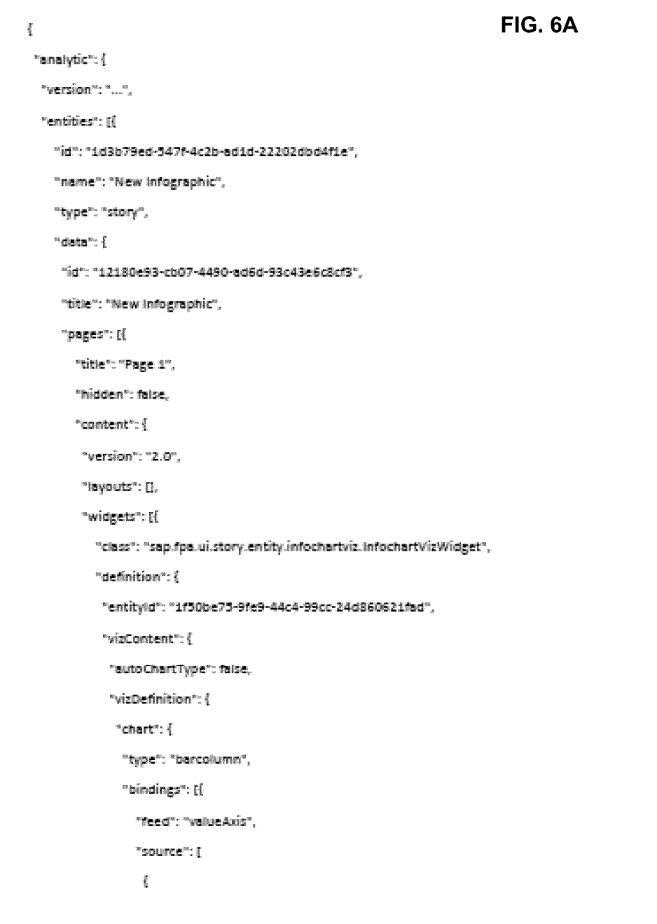

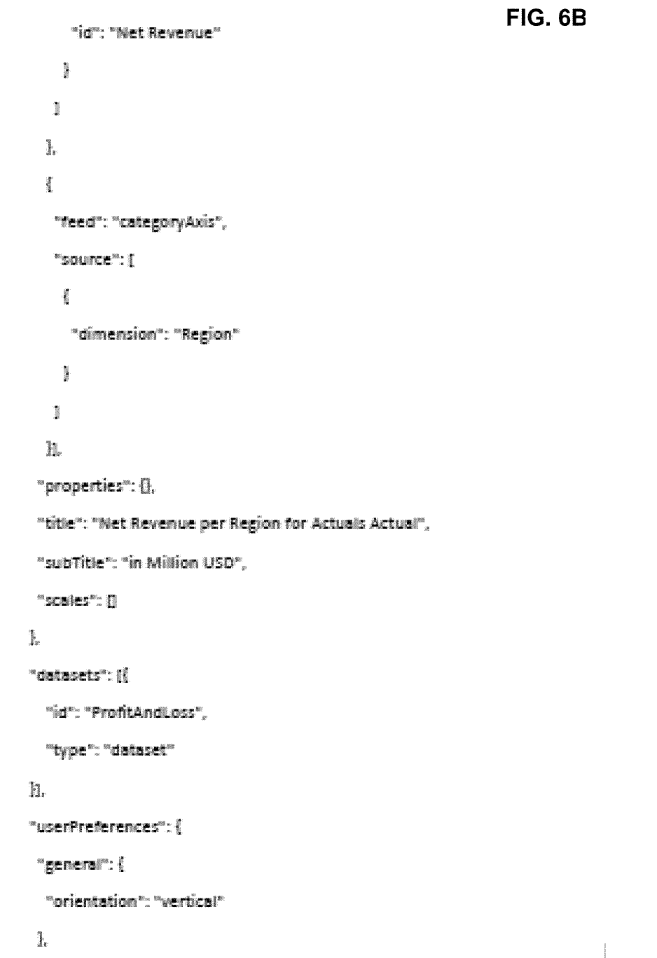

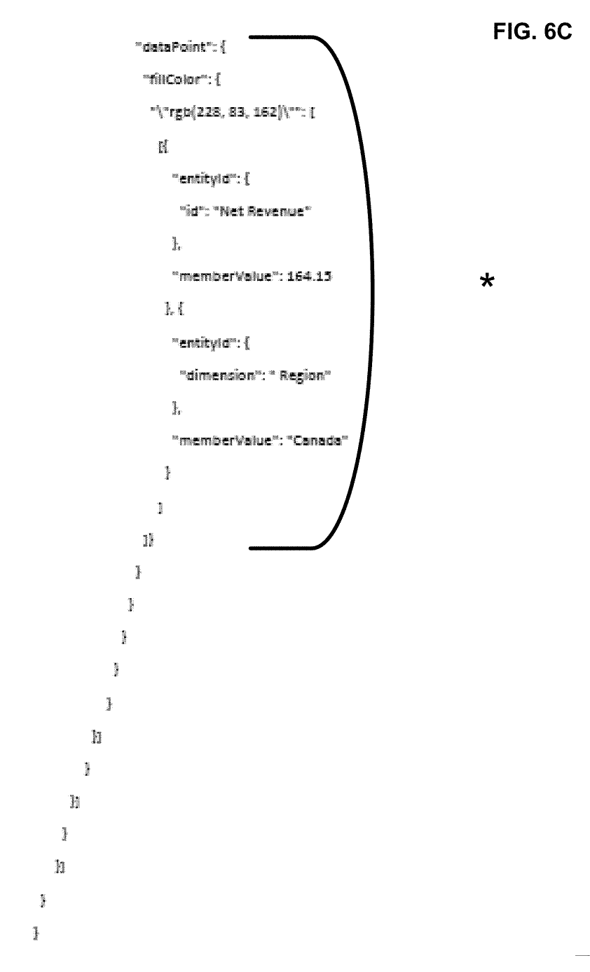

Metadata Table

| ID | Name | Metadata |
|---|---|---|
| <id of the story> | <textual name of story> | {... JSON ...} |
| Example: “id12345” | Example: “My story” | Example: FIGS. 6A-C |

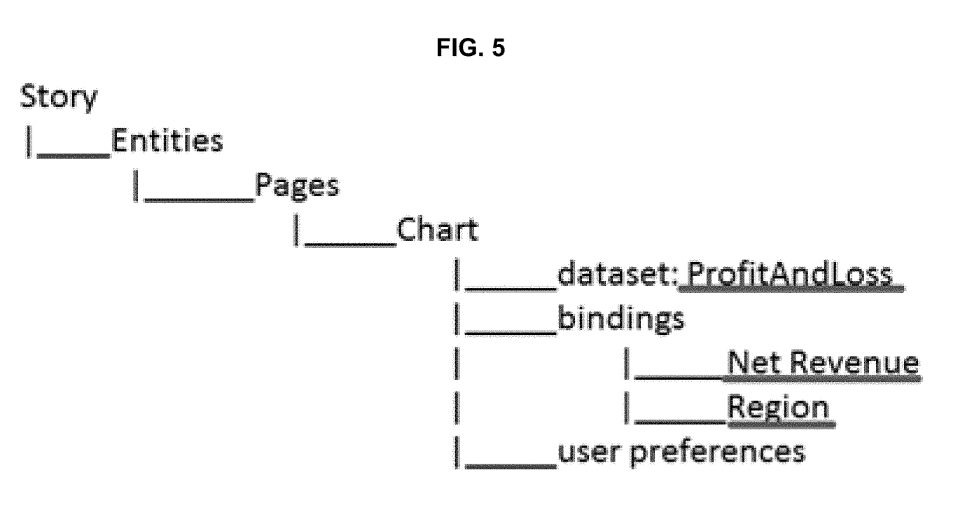

In particular, the story metadata is stored in the metadata table as a JavaScript Object Notation (JSON) object 415. FIG. 5 shows the hierarchical structure of the story JSON object. FIGS. 6A-C show a story JSON object having the hierarchical structure of FIG. 5.

The hierarchical structure of FIG. 5 indicates that the actual data supplied to the story (i.e., bar chart) in this example, is not stored in the story JSON object. Rather, the actual data for the chart visualization is instead stored in the “ProfitAndLoss” dataset, and bindings of the two columns of “Net Revenue” and “Region” from that dataset.

Returning now to FIG. 4, upon receipt of the story JSON object from the server, the client reads the metadata of each chart. The client asks 416 the server for the data to be consumed in the chart. Here, that data are the Net. Rev. and Region columns from the ProfitAndLoss dataset.

The server then issues a query 418 to a fact table 420 that is stored in the database.

Fact Table

| | | | | Income | Net Rev. | Tax | Costs |
|---|---|---|---|---|---|---|---|
| Region | Product | Currency | Time | Stmt (M$) | (M$) | (M$) | (M$) |
| Canada | Shirts | CAD | 2014 | 100.15 | 120.15 | −10.00 | −10.00 |
| Canada | Accessories | CAD | 2014 | 45.00 | 64.00 | −12.00 | −7.00 |
| US | Shirts | USD | 2014 | 73.00 | 80.40 | −5.40 | −2.00 |
| US | Accessories | USD | 2014 | 19.02 | 26.02 | −6.00 | −1.00 |

A query result set 422 is returned in response to the query. This data read from the fact table is sent back to the client as a data JSON object 424.

Unlike the metadata table (which already has everything saved as JSON), the fact table is in the form of tabular data. Thus, the server transforms that fact table into the data JSON object.

It is noted that in certain embodiments, the database may comprise an in-memory database having a powerful in-memory database engine. In those embodiments, the in-memory database engine may perform the transformation of the fact table into the data JSON object.

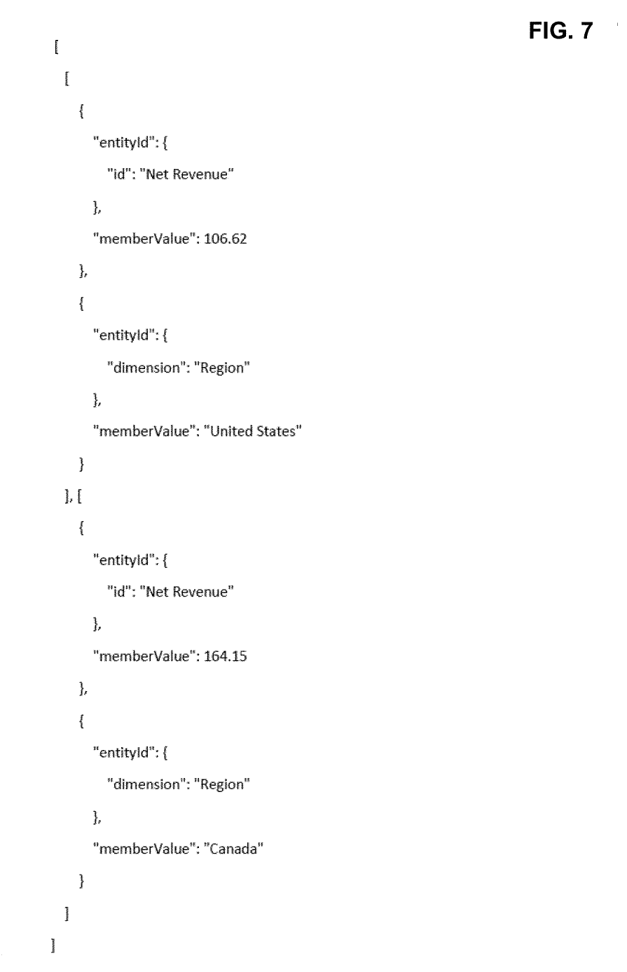

FIG. 7 shows the data JSON object according to this example. Each of the tuples of the JSON object of FIG. 7:

### Region=Canada, NetRev=164.15, and

### Region=United States, NetRev=106.62

are mapped to respective columns of the chart 802 of the story page 800 shown in FIG. 8.

Specifically, once the story JSON is retrieved (including user preferences for each chart), and the data for the chart is retrieved, the client-side (i.e. browser) is ready to render the chart for the user. To understand this rendering process, two main components of the code may be considered: parsing and charting.

FIG. 8A is a simplified flow diagram illustrating a process 810 for rending a chart from a JSON object received from the server. The parsing code 812 is responsible to receive the JSON objects and “parse” them into chart JSON objects 813 appropriate for input to the charting.

The parser builds the chart JSON objects in a form that is recognized by the charting. This input to the charting is also in JSON format, but it is different from what is received from the server.

The charting code 814 is then responsible for drawing/displaying the chart for review by the user. Here, the action of drawing the chart refers to building a client-side Hypertext Markup Language (HTML)/Scalable Vector Graphics (SVG) element 815 which describes the graphics to the browser.

In this example, the application of styling to particular chart elements is based upon user preferences of the story JSON object. Such application of user preferences to impose styling upon a chart element, may take place in at least two ways.

According to a first approach, rendering a chart with styling utilizes multiple round trips of calls between the parser component and the charting component. This approach is illustrated in FIG. 8B.

Here, user preferences are applied using one or multiple additional calls from the parser to the charting. In the workflow of FIG. 8B, the parser recognizes the chart element in the story JSON.

The parser makes a first call to render the chart without any of the user specified styling—a bare minimum chart. Then, the parser parses the user preferences, and makes additional (second, third) calls to apply coloring and other user preferences.

FIG. 8B shows the parser making multiple calls to charting. A first call causes the initial chart to be created (as HTML/SVG elements). Subsequent calls update the chart elements (e.g., dictating that the bar for Canada is colored red).

Each user preference of the story JSON object, is a separate call to the charting component. A sample for input for each of the calls is as follows:

Chart JSON: { data: { . . . }, properties: { . . . } }
User pref1: { dataPoint: { color: “rgb(123,56,34)” } }

Thus in the approach of FIG. 8B, the bar in bar chart for Canada may be initially rendered with a default color (e.g., orange). In the subsequent calls between parser and charting component, that color is changed to a different one depending upon the user preferences.

According to this multi-call approach, an order in which the parser issues the calls may be based upon a scope of the user preference and/or a scope of the data fitting that user preference. For example, an engine may direct the parser to issue calls specifying a least restrictive user preference, before calls specifying a more restrictive user preference. This is discussed further below in connection with the application of precedence rules.

Another approach to the application of user preferences to chart styling, involves rendering based on a single round trip between parser and charting component. That alternative approach is illustrated in FIG. 8C.

According to this second approach the parser receives the initial JSON object, and then enriches that object with specific code to create an enhanced chart JSON object that includes coloring of the data points. Therefore, additional calls are not required.

Accordingly, the parser will perform the entire parsing and builds a single enhanced JSON object (larger than the JSON of FIG. 8B). In this alternative approach, the charting will directly create the bar with the red color in the first draw/render. So, there is no procedure for extra calls to change the color of the bar to red.

According to this second approach, code input for the charting will look like:

Chart JSON: { data: { . . . }, properties: { . . . , dataPoint: { color: “rgb(123,56,34)” } } }

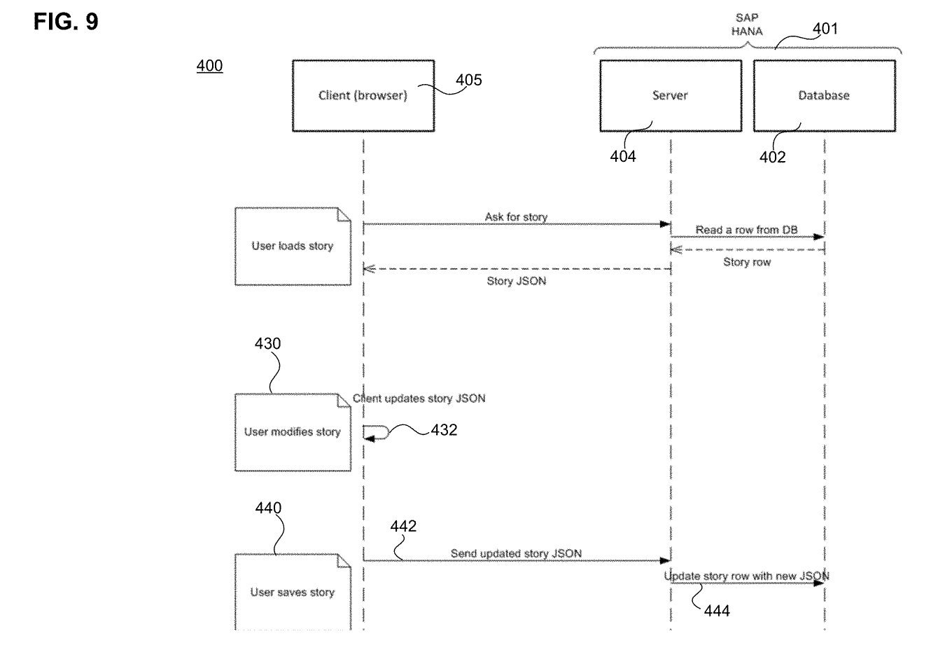

FIG. 9 again shows the Cloud Analytics system 400. This figure shows that once the story has been loaded onto the client browser, the user can interact with and update 430 the story JSON. One example of such updating is to impose stylings on elements of the chart visualization.

Specifically, as shown in FIG. 10, controls 1002 for the user interface (UI) 1000 on the browser, allow the user to select specific properties for chart elements. Here, those UI controls may permit user selection of the color purple for the net revenue for Canada.

FIG. 11 shows that the color of the Canada bar of the chart is changed (reflected by hatching) according to the user update. Moreover, upon the user making this change to this chart of the story, a JSON description of the coloring is added to the story JSON.

As a bar of the story chart is selected and its color is changed, embodiments look back via a mapping to the JSON representation of data, and find the corresponding contextual description of the chart element that has been selected.

{

“entityId”: {

“id”: “Net Revenue”

},
“memberValue”: 164.15

},
{

“entityId”: {

“dimension”: “ Region”

},
“memberValue”: “Canada”

}

Now, given that the subset of the data relating to a specific selected bar/column is known (i.e., 164.15, Canada), embodiments can store the styling information with regard to the context of the chart.

Here, styling information is stored as part of the story JSON object as the “userPreferences” key. This provides a mapping from the color to the data value in the chart.

Thus according to the hierarchical structure of the story JSON object shown in FIG. 5, this coloring description is found at the user preferences level. In the story JSON object shown in FIGS. 6A-C, the code corresponding to this coloring description is indicated with an asterisk.

Returning to FIG. 9, the user then saves 440 the modified story (e.g., changed to include the style for the color of the net revenue in Canada). In this example, the updated story JSON is sent 442 to the server, and server metadata in the database is updated 444, only when user explicitly instructs the story to be saved.

Now, the story JSON has been updated to reflect the chart styling at the data level (e.g., based upon metadata stored within the database at the remote server). This allows the browser UI to automatically update the story when viewed again.

Such storing of chart style at the data level, offers the advantage of consistently depicting the same data with a same appearance (as determined by the metadata).

Suppose, for example, that the user sought to visualize the same net revenue per region data for Canada and the United States, in a different chart format (e.g., a pie chart). Embodiments accordingly allow locating that particular chart element relating to the tuple which is colored purple:

### Region=Canada, NetRev=164.15.

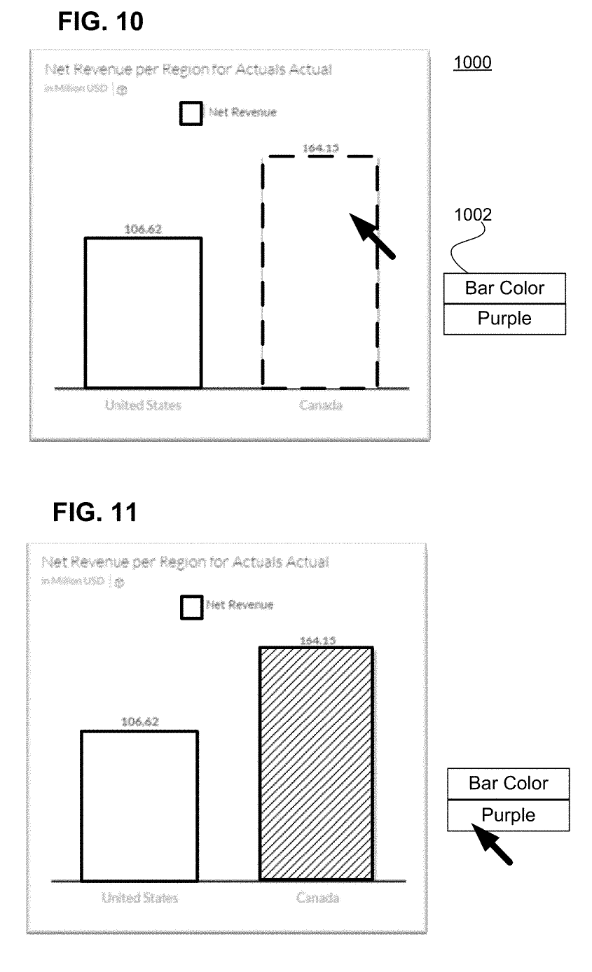

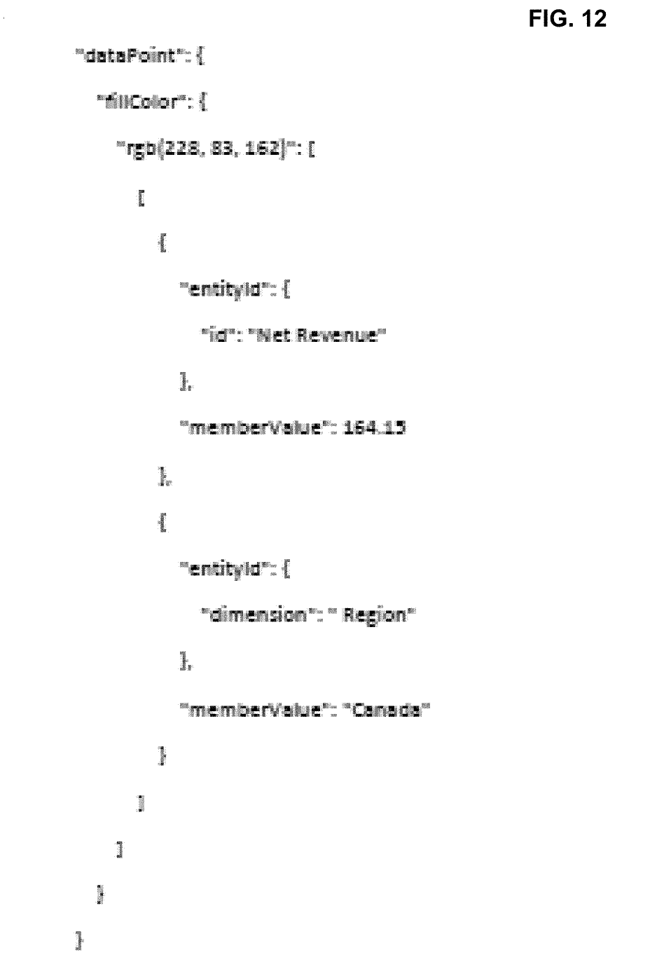

This is shown in the code of FIG. 12.

As a result, the user interface may now map to the appropriate chart element (pie slice) in the new chart (pie chart), in order to assign a color. FIG. 13 shows a resulting pie chart receiving the same coloring based upon the stored contextual styling.

In particular, the pie slice for Canada is again colored purple because the represented data is associated with the purple color. This coloration according to styling is produced as a result of data in the data level, and does not occur by manual action of the user at the visualization level.

It is further noted that the assignment of stylings to chart elements may proceed according to a precedence scheme. For example, a story JSON may indicate a default color for the “NetRev” dimension.

Subsequent user interaction may establish different stylings that overlap and potentially conflict with one another. Under such circumstances, the assignment of chart styling may be resolved by the application of precedence rules.

Consider the following workflow:

1. the user chooses Net Revenue to be red;
2. the user chooses Net Revenue for Canada to be purple.

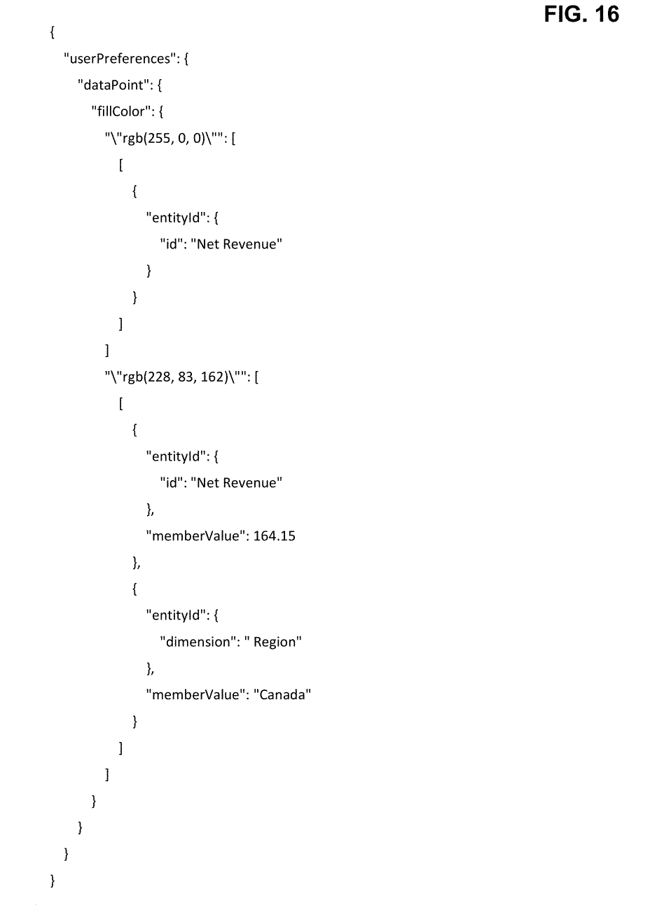

These stylings can be saved as user preferences by listing them one after another in the JSON. FIG. 16 shows this in the context of the JSON object of FIGS. 6A-C.

In FIG. 16, the color red (designated as rgb(255, 0, 0)) is linked to Net Revenue. The color purple (rgb(228, 83, 162)) is assigned to Net Revenue and Canada. So, they are simply inserted into the JSON side by side.

However, the manner in which these user preferences are applied to determine an ultimate styling of a chart element, depends upon an order in which the rendering (parsing and charting) is actually performed.

Recall that FIG. 8B shows a rendering approach involving multiple round trip calls between the parser and the charting component. There, one call is made from the parser to the charting component for each user preference. So one call will be made to render Net Revenue red, and another call will be to render Canada purple.

Under this multi-call approach, the order in which the calls are made determines the final appearance of the chart styling. Returning to the simplified story example of FIG. 8, there are two bars: one for Canada, and one for US.

If the call: Net Revenue->Red is applied as the first call, the color of both bars (Canada, US) will change to red. Then, if the call: Net Revenue&Canada->Purple is subsequently applied, only one of the bars (Canada) changes to purple. The ultimate result is that the bar for US is red, and the bar for Canada is purple.

A scheme for determining precedence may thus be summarized as: “the less restricting user preference should be applied first”. Here the less restricting preference comprises a shorter user preference (having only net revenue as a condition, vs. having the conditions net revenue and Canada), or a user preference producing a larger query result matching more data points (2 data points instead of 1).

This less restricting preference may be determined by the engine analyzing the conditions comprising the user preference, and the volume of matched data resulting from application of the user preference to the dataset. Thus in the above example, the engine determines that Net Revenue->Red is the less restricting precedence rule, and should be applied before the other precedence rule (Net Revenue & Canada->Purple). The order of applying the user preferences thus determines the final styling rendered in the chart.

The other rendering approach shown in FIG. 8C, involves only a single round trip. Here, determining precedence involves expanding the precedence rules.

Considering the same workflow as above, the rule may be expanded as follows:

### 1—Net Revenue->Red----------->Net Revenue&Canada->Red, Net Revenue&US->Red

### 2—Net Revenue&Canada->Purple----------------------------->Net Revenue&Canada->Purple

Subtracting the second rule from the first, leaves the following two rules:

### 1—Net Revenue&US->Red

### 2—Net Revenue&Canada->Purple

This modification of precedence rules takes place in the parser. So under the single-call approach, the color of each bar is explicitly determined by the parser. This may be contrasted with the multi-call approach which naturally selects the colors based upon the last rule applied.

In summary, this example adds controls to the UI in the visualization layer (browser), which allow a user to select styling (e.g., color) for chart elements. In response to this selection, code present on the client updates the story JSON object to add a description of the styling. That updated story JSON object is stored associated with the data on the data layer.

When the story is viewed again, the user interface then styles the same data point in the same manner. This is particularly useful because the styling is persisted without further manual action by the user.

This instant approach of implementing chart styles at the data level, may offer one or more benefits. For example, the coloring is saved in association with the underlying data rather than with chart elements

This association of style with stored data is persisted and can be applied to the chart every time a story is viewed. Moreover, the association of style with stored data allows automatic transfer of visual properties from one chart to the other (e.g. from a bar chart to a pie chart).

The above example is provided for purposes of illustration only, and is not intended to limit available embodiments. Thus while the example describes storing chart color as a style, one or more other visualization properties (e.g., data point size, data point symbol, text font, bolding/italics, background color, highlighting, etc.) could also be stored in association with relevant data at the data level. Various elements of a chart having styles assigned thereto can include the data itself, but can also include chart axes (e.g., thickness, color, dashed line appearance), chart borders (e.g., thickness, color, dashed line appearance), and/or chart legends (e.g., text color, size, font, bolding/italics).

And, while FIG. 1 shows the visualization engine as part of an application layer overlying a database layer, this is not required. In certain embodiments, the visualization engine may be implemented by a database engine, such as an in-memory database engine. One example of such an in-memory database engine is the HANA in-memory database available from SAP SE of Walldorf, Germany.

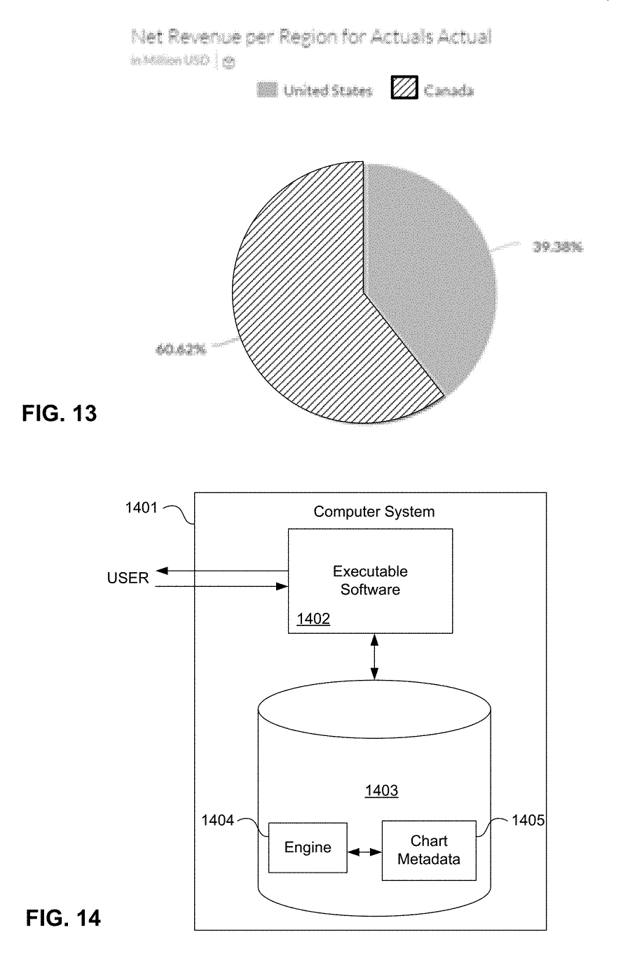

For example, FIG. 14 illustrates hardware of a special purpose computing machine configured to implement contextual stylizing of chart elements according to an embodiment. In particular, computer system 1401 comprises a processor 1402 that is in electronic communication with a non-transitory computer-readable storage medium 1403. This computer-readable storage medium has stored thereon code 1405 corresponding to chart metadata. Code 1404 corresponds to an engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

It is noted that in the specific embodiment of FIG. 14, the engine is shown as being part of a database. Such an embodiment can correspond to applications performing processing by a powerful engine available as part of an in-memory database (e.g., the HANA in-memory database available from SAP SE of Walldorf, Germany). However, this not required and in certain embodiments (e.g., that shown in FIG. 1) the engine may be implemented in other ways, for example as part of an overlying application layer.

Moreover, while FIG. 1 shows a set of precedence rules as being present in the same database as the metadata and data, this is also not required. In certain embodiments precedence information could be stored in a separate database. Alternatively, in some embodiments the precedence information could be stored in the metadata table.

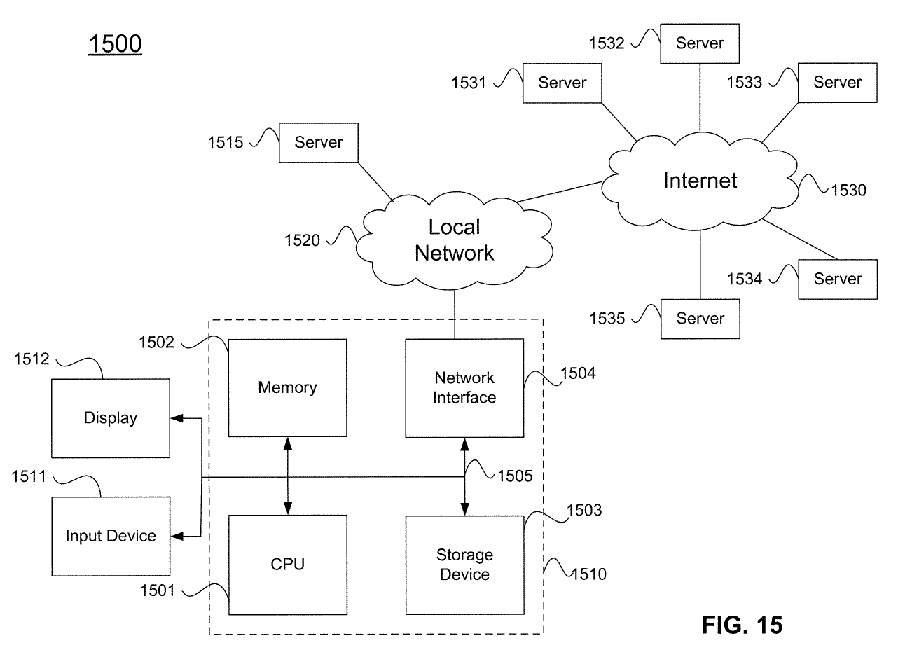

An example computer system 1500 is illustrated in FIG. 15. Computer system 1510 includes a bus 1505 or other communication mechanism for communicating information, and a processor 1501 coupled with bus 1505 for processing information.

Computer system 1510 also includes a memory 1502 coupled to bus 1505 for storing information and instructions to be executed by processor 1501, including information and instructions for performing the techniques described above, for example. This memory may also be used for storing variables or other intermediate information during execution of instructions to be executed by processor 1501. Possible implementations of this memory may be, but are not limited to, random access memory (RAM), read only memory (ROM), or both. A storage device 1503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1503 may include source code, binary code, or software files for performing the techniques above, for example. Storage device and memory are both examples of computer readable mediums.

Computer system 1510 may be coupled via bus 1505 to a display 1512, such as a cathode ray tube (CRT) or liquid crystal display (LCD), for displaying information to a computer user. An input device 1511 such as a keyboard and/or mouse is coupled to bus 1505 for communicating information and command selections from the user to processor 1501. The combination of these components allows the user to communicate with the system. In some systems, bus 1505 may be divided into multiple specialized buses.

Computer system 1510 also includes a network interface 1504 coupled with bus 1505. Network interface 1504 may provide two-way data communication between computer system 1510 and the local network 1520. The network interface 1504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1504 sends and receives electrical, electromagnetic, or optical signals that carry digital data streams representing various types of information.

Computer system 1510 can send and receive information, including messages or other interface actions, through the network interface 1504 across a local network 1520, an Intranet, or the Internet 1530. For a local network, computer system 1510 may communicate with a plurality of other computer machines, such as server 1515. Accordingly, computer system 1510 and server computer systems represented by server 1515 may form a cloud computing network, which may be programmed with processes described herein. In the Internet example, software components or services may reside on multiple different computer systems 1510 or servers 1531-1535 across the network. The processes described above may be implemented on one or more servers, for example. A server 1531 may transmit actions or messages from one component, through Internet 1530, local network 1520, and network interface 1504 to a component on computer system 1510. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
rendering a chart element for data from a fact table in a database, the chart element having an appearance based upon metadata from a metadata table in the database;
receiving a first input to change the appearance;
in response to the first input,
rendering the chart element with a changed appearance, and
storing in the metadata table, updated metadata reflecting the changed appearance;
receiving a second input to display the data; and
in response to the second input, automatically rendering the data with the changed appearance according to the updated metadata.

2. A method as in claim 1 wherein:
the updated metadata comprises a user preference; and
the data is rendered with the changed appearance according to a precedence rule.

3. A method as in claim 2 wherein to automatically render the data with the changed appearance, the precedence rule instructs a parser to apply the updated metadata after applying the metadata.

4. A method as in claim 3 wherein the precedence rule is based upon a scope of restriction of the user preference.

5. A method as in claim 4 wherein the scope of restriction reflects a number of conditions of the user preference or an amount of data matching the user preference.

6. A method as in claim 2 wherein the precedence rule instructs a parser to modify an existing precedence rule.

7. A method as in claim 1 wherein a charting component automatically renders the data with the changed appearance in response to a plurality of calls from a parser.

8. A method as in claim 1 wherein a charting component automatically renders the data with the changed appearance in response to a single call from a parser.

9. A non-transitory computer readable storage medium embodying a computer program for performing a method, said method comprising:
rendering a chart element for data from a fact table in a database, the chart element having an appearance based upon metadata from a metadata table in the database;
receiving a first input to change the appearance;
in response to the first input,
rendering the chart element with a changed appearance, and
storing in the metadata table, updated metadata reflecting the changed appearance;
receiving a second input to display the data; and
in response to the second input, processing the updated metadata according to a precedence rule to automatically render the data with the changed appearance.

10. A non-transitory computer readable storage medium as in claim 9 wherein to automatically render the data with the changed appearance, the precedence rule instructs a parser to apply the updated metadata after applying the metadata.

11. A non-transitory computer readable storage medium as in claim 9 wherein:
the updated metadata comprises a user preference; and
the precedence rule is based upon a scope of restriction of the user preference.

12. A non-transitory computer readable storage medium as in claim 11 wherein the scope of restriction reflects a number of conditions of the user preference or an amount of data matching the user preference.

13. A non-transitory computer readable storage medium as in claim 9 wherein a charting component automatically renders the data with the changed appearance in response to a plurality of calls from a parser.

14. A non-transitory computer readable storage medium as in claim 9 wherein a charting component automatically renders the data with the changed appearance in response to a single call from a parser.

15. A computer system comprising:
one or more processors;
a software program, executable on said computer system, the software program configured to cause an in-memory database engine to:
render a chart element for data from a fact table in an in-memory database, the chart element having an appearance based upon metadata from a metadata table in the in-memory database;
receive a first input to change the appearance;
in response to the first input,
render the chart element with a changed appearance, and
store in the metadata table, updated metadata including a user preference reflecting the changed appearance;
receive a second input to display the data; and
in response to the second input, process the updated metadata according to a precedence rule to automatically render the data with the changed appearance.

16. A computer system as in claim 15 wherein to automatically render the data with the changed appearance, the precedence rule instructs a parser to apply the updated metadata after applying the metadata.

17. A computer system as in claim 15 wherein the precedence rule is based upon a scope of restriction of the user preference.

18. A computer system as in claim 17 wherein the scope of restriction reflects a number of conditions of the user preference or an amount of data matching the user preference.

19. A computer system as in claim 15 wherein a charting component automatically renders the data with the changed appearance in response to a plurality of calls from a parser.

20. A computer system as in claim 15 wherein a charting component automatically renders the data with the changed appearance in response to a single call from a parser.
